(19) United States
(12) Patent Application Publication
(10) Pub. No.: US 2025/0048204 A1
(43) Pub. Date: Feb. 6, 2025

(54) USER EQUIPMENT TYPE SWITCHING

(71) Applicant: Nokia Technologies Oy, Espoo (FI)

(72) Inventors: Lei DU, Beijing (CN); Lars DALSGAARD, Oulu (FI); Petri Juhani VASENKARI, Espoo (FI)

(21) Appl. No.: 18/750,623

(22) Filed: Jun. 21, 2024

(30) Foreign Application Priority Data
Aug. 2, 2023 (WO) PCT/CN2023/110687

(51) Int. Cl. H04W 36/00; H04L 27/26; H04W 36/18

(52) U.S. Cl. CPC H04W 36/008355; H04L 27/2666; H04W 36/18

(57) ABSTRACT

Embodiments of the present disclosure relate to UE type switching. In an aspect, a terminal device transmits, to a network device, capability information indicating support of a plurality of types of the terminal device. Then, the network device transmits an indication for switching a type of the terminal device to the terminal device. Moreover, the terminal device performs type switching based on the indication and a requirement for an interruption caused by the type switching. In this way, it is allowed to avoid transmission failure due to the interruption caused by type switching, and thus improve resource utilization and transmission flexibility.

### CROSS REFERENCE TO RELATED APPLICATION

This application claims the benefit of PCT application No. PCT/CN2023/110687 filed on 2 Aug. 2023, the contents of which are incorporated herein by reference in their entirety.

### FIELD

Various example embodiments relate to the field of communications and in particular, to devices, methods, apparatuses, and computer readable storage media for user equipment (UE) type switching.

### BACKGROUND

In communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for increased wireless data traffic since the deployment of 4th generation (4G) communication systems, efforts have been made to develop an improved 5th generation (5G), pre-5G, or 5G-advanced communication system. The new communication systems can support various types of service applications for terminal devices.

According to the radio access network (RAN) workgroup 4 (RAN4) discussions, Type 1 and Type 2 UE architectures are differentiated by the number of receive (Rx) chains. The UE with Type 1 architecture receives from intra-band carriers via a single Rx chain (or with single fast Fourier transform (FFT) assumption). The UE with Type 2 receives via separate Rx chains (or with separate FFTs and low noise amplifiers (LNAs) and antennas) from different bands or from different carriers on the same band or overlapping bands. UE type switching between the Type 1 and Type 2 has also been discussed. However, there are still some open problems in such UE type switching that will be studied in the near future.

### SUMMARY

In general, example embodiments of the present disclosure provide a solution related to UE type switching.

In a first aspect, there is provided a terminal device. The terminal device comprises at least one processor and at least one memory storing instructions that, when executed by the at least one processor, cause the terminal device at least to: transmit, to a network device, capability information indicating support of a plurality of types of the terminal device; receive, from the network device, an indication for switching a type of the terminal device; and perform type switching based on the indication and a requirement for an interruption caused by the type switching.

In a second aspect, there is provided a first network device. The first network device comprises at least one processor and at least one memory storing instructions that, when executed by the at least one processor, cause the first network device at least to: receive, from a terminal device, capability information indicating support of a plurality of types of the terminal device; transmit, to the terminal device, an indication for switching a type of the terminal device; and determine scheduling of the terminal device based on the indication and a requirement for an interruption caused by type switching at the terminal device.

In a third aspect, there is provided a second network device. The second network device comprises at least one processor and at least one memory storing instructions that, when executed by the at least one processor, cause the second network device at least to: receive, from a first network device, a terminal switching indication indicating switching of a type of a terminal device; and determine scheduling of the terminal device based on a requirement for an interruption caused by type switching at the terminal device.

In a fourth aspect, there is provided a method. The method comprises transmitting, at a terminal device, to a network device, capability information indicating support of a plurality of types of the terminal device; receiving, from the network device, an indication for switching a type of the terminal device; and performing type switching based on the indication and a requirement for an interruption caused by the type switching.

In a fifth aspect, there is provided a method. The method comprises receiving, at a first network device, from a terminal device, capability information indicating support of a plurality of types of the terminal device; transmitting, to the terminal device, an indication for switching a type of the terminal device; and determining scheduling of the terminal device based on the indication and a requirement for an interruption caused by type switching at the terminal device.

In a sixth aspect, there is provided a method. The method comprises receiving, at a second network device, from a first network device, a terminal switching indication indicating switching of a type of a terminal device; and determining scheduling of the terminal device based on a requirement for an interruption caused by type switching at the terminal device.

In a seventh aspect, there is provided an apparatus. The apparatus comprises means for transmitting. at a terminal device, to a network device, capability information indicating support of a plurality of types of the terminal device; means for receiving, from the network device, an indication for switching a type of the terminal device; and means for performing type switching based on the indication and a requirement for an interruption caused by the type switching.

In an eighth aspect, there is provided an apparatus. The apparatus comprises means for receiving, at a first network device, from a terminal device, capability information indicating support of a plurality of types of the terminal device; means for transmitting, to the terminal device, an indication for switching a type of the terminal device; and means for determining scheduling of the terminal device based on the indication and a requirement for an interruption caused by type switching at the terminal device.

In a ninth aspect, there is provided an apparatus. The apparatus comprises means for receiving, at a second network device, from a first network device, a terminal switching indication indicating switching of a type of a terminal device; and determining scheduling of the terminal device based on a requirement for an interruption caused by type switching at the terminal device.

In a tenth aspect, there is provided a non-transitory computer readable medium comprising program instructions for causing an apparatus to perform at least the method according to any one of the above fourth to sixth aspects.

In an eleventh aspect, there is provided a computer program comprising instructions, which, when executed by an apparatus, cause the apparatus at least to perform at least the method according to any one of the above fourth to sixth aspects.

In a twelfth aspect, there is provided a terminal device. The terminal device comprises transmitting circuitry configured to transmit, to a network device, capability information indicating support of a plurality of types of the terminal device; receiving circuitry configured to receive, from the network device, an indication for switching a type of the terminal device; performing circuitry configured to and perform type switching based on the indication and a requirement for an interruption caused by the type switching.

In a thirteenth aspect, there is provided a first network device. The first network device comprises receiving circuitry configured to receive, from a terminal device, capability information indicating support of a plurality of types of the terminal device; transmitting circuitry configured to transmit, to the terminal device, an indication for switching a type of the terminal device; and determining circuitry configured to determine scheduling of the terminal device based on the indication and a requirement for an interruption caused by type switching at the terminal device.

In a fourteenth aspect, there is provided a second network device. The second network device comprises receiving circuitry configured to receive, from a first network device, a terminal switching indication indicating switching of a type of a terminal device; and determining circuitry configured to determine scheduling of the terminal device based on a requirement for an interruption caused by type switching at the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example environment in which example embodiments of the present disclosure can be implemented;

FIG. 1B illustrates an example UE architecture with Type 2 associated with some example embodiments of the present disclosure;

FIG. 1C illustrates an example UE type switching associated with some example embodiments of the present disclosure;

FIG. 2 illustrates a signaling flow among a terminal device, a first network device, and a second network device according to some example embodiments of the present disclosure;

FIG. 3 illustrates an example UE type switching process according to some example embodiments of the present disclosure;

FIG. 4 illustrates a flowchart of a method implemented at a terminal device according to some embodiments of the present disclosure;

FIG. 5 illustrates a flowchart of a method implemented at a first network device according to some embodiments of the present disclosure;

FIG. 6 illustrates a flowchart of a method implemented at a second network device according to some embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), an NR NB (also referred to as a gNB), a remote radio unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Hereinafter, principles and embodiments of the present disclosure will be described in detail below with reference to the accompanying drawings.

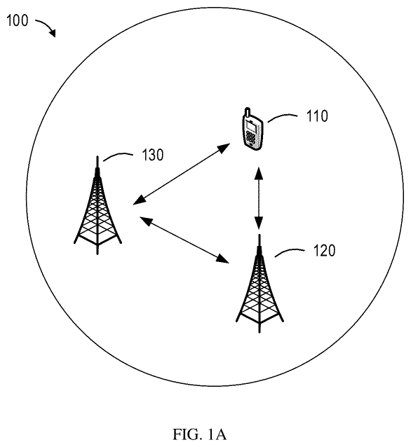

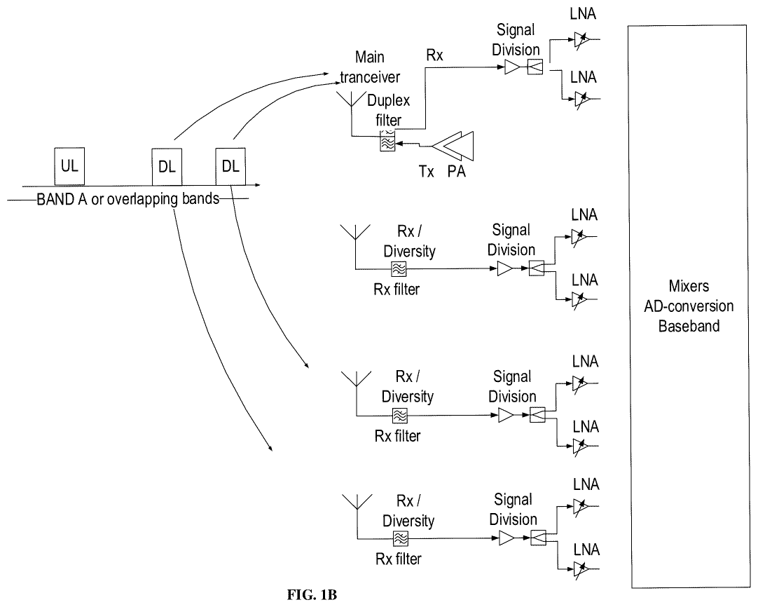

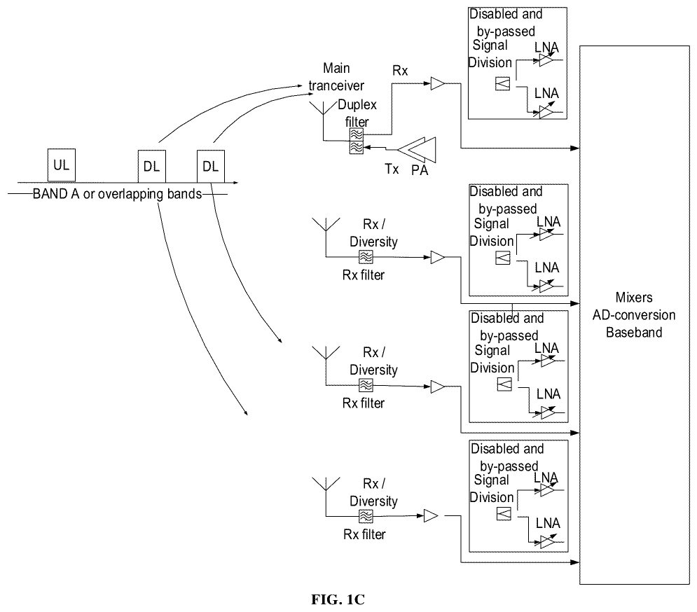

Reference is first made to FIG. 1A, which illustrates an example environment 100 in which example embodiments of the present disclosure can be implemented. The environment 100, which may be a part of a communication network, comprises a terminal device 110, network devices 120 and 130 (referred to as a first network device 120 and a third network device 130). The communication among the terminal device 110, the first network device 120 and the second network device 130 may be direct or indirect. As an example, the terminal device 110, the first network device 120 and the second network device 130 may communicate with one or more further devices not shown in FIG. 1A.

In some example embodiments for intra-band non-collocated NR-CA scenarios, a first cell provided by the first network device 120 and a second cell provided by the second network device 120 are non-collocated. The first network device 120 may provide a primary cell (PCell) for the terminal device 110, and the second network device 130 may provide a secondary cell (SCell) for the terminal device 110 to operate with carrier aggregation (CA).

In some example embodiments for inter-band EN-DC scenarios with overlapping bands, the first network device 120 may comprise a master node and the second network device 130 may comprise a secondary node. The master node and the secondary node may be served as dual connectivity for the terminal device 110. The first network device 120 may provide a master cell group (MCG) for the terminal device 110 and the second network device 130 may provide a secondary cell group (SCG) for the terminal device 110.

To transmit data and/or control information, the first device 110 may perform communications with the first network device 120 and/or the second network device 130. A link from the first network device 120 and/or the second network device 130 to the terminal device 110 is referred to as a downlink (DL), while a link from the terminal device 110 to the first network device 120 and/or the second network device 130 is referred to as an uplink (UL).

Although the terminal device 110, the first network device 120, and the second network device 130 are described in the communication environment 100 of FIG. 1A, embodiments of the present disclosure may equally apply to any other suitable communication devices in communication with one another. That is, embodiments of the present disclosure are not limited to the exemplary scenarios of FIG. 1A. In this regard, it is noted that although the terminal device is schematically depicted as a mobile phone and the first network device 120 and the second network device 130 are schematically depicted as a base station in FIG. 1A, it is understood that these depictions are exemplary in nature without suggesting any limitation. In other embodiments, the first device 110, the first network device 120 and the second network device 130 may be any other communication devices, for example, any other wireless communication devices.

It is to be understood that the particular number of various communication devices and the particular number of various communication links as shown in FIG. 1A is for illustration purpose only without suggesting any limitations. The communication environment 100 may include any suitable number of communication devices and any suitable number of communication links for implementing embodiments of the present disclosure. In addition, it should be appreciated that there may be various wireless as well as wireline communications (if needed) among all of the communication devices.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connectivity (DC), and New Radio Unlicensed (NR-U) technologies.

As described above, according to RAN4 discussions, Type 1 and Type 2 UE architectures are differentiated by the number of Rx chains. Type 1 is the baseline or legacy architecture that has been used for intra-band new radio carrier aggregation (NR-CA) and intra-band evolved-universal terrestrial radio access network new radio dual connectivity (EN-DC) (where collocation deployment is always assumed). The UE with Type 1 receives from intra-band carriers via a single Rx chain (or with a single FFT assumption). Type 2 has been assumed to support inter-band operation including inter-band NR-CA and inter-band EN-DC. Since release 16, it is further agreed to be able to support frequency range 1 (FR1) intra-band non-collocated scenarios. Herein the intra-band non-collocated scenarios include intra-band non-collocated NR-CA and intra-band non-collocated EN-DC which is also called inter-band EN-DC with overlapping bands. The UE with Type 2 receives via separate Rx chains (or with separate FFTs and LNAs and antennas) from different bands in case of inter-band scenarios or different carriers on the same band or overlapping bands in case of intra-band non-collocated scenarios.

Until release 17 (Rel-17), only the collocated scenario has been assumed when defining the RRM requirements for FR1 intra-band NR-CA, but from the operators' perspective, UE requirements for non-co-located deployment are essential to enhance the EN-DC/NR-CA available areas. In release 18 (Rel-18), in RAN #95e meeting, a RAN4 work item (WI) RP-221004 was approved to define the UE requirements supporting intra-band non-collocated EN-DC/NR-CA deployment. The WI description (WID) was further updated at RAN #96 in RP-221809 as follows, where RRM requirements need to be revisited or defined to support FR1 intra-band non-collocated scenarios.

```
4.1 Objective of SI or Core part WI or Testing part WI
The core part of the work item includes:
...
Phase II:
  Phase II work will get started after the feasibility in phase I is confirmed
  Specify MRTD and MTTD requirements in non-collocated deployment
  Discuss and decide if the different requirements will be specified based
  on UE
  capability of interBandMRDC-WIthOverlapDL-Bands-r16.
```

The support of intra-band non-collocated EN-DC is indicated by the UE capability “interBandMRDC-WithOverlapDL-Bands-r16” which was defined in release 16 (Rel-16) as below.

| | | | | |
|---|---|---|---|---|
| interBandMRDC-WithOverlapDL-Bands-r16 | BC | No | N/A | FR1 |
| Indicates the UE supports FDD-FDD or TDD-TDD inter- | | | | only |
| band (NG)EN-DC/NE-DC operation with overlapping or | | | | |
| partially overlapping DL bands with an (NG)EN-DC/NE- | | | | |
| DC MRTD according to clause 7.6.2/7.6.5 in 38.133 [5] | | | | |
| and inter-band RF requirements (i.e Type 2 UE). If the | | | | |
| capability is not reported, the UE supports FDD-FDD or | | | | |
| TDD-TDD inter-band operation with overlapping or | | | | |
| partially DL bands with (NG)EN-DC/NE-DC | | | | |
| MRTD<3us according to clause 7.6.3 in 38.133 [5] and | | | | |
| intra-band RF requirements (i.e. Type 1 UE). | | | | |

In the RAN4 #107 meeting, a similar UE capability [intraBandNonColocatedCA-r18] was also introduced for non-collocated intra-band NR-CA as follows. In any case, the UE indicating this capability is considered as Type 2 UE, and the network can configure the band combination with potential non-collocated deployment for FR1 intra-band CA/EN-DC e.g. n42+n77/78. Otherwise, the network shall not configure such band combination.

```
RAN4#107 Agreement:
  Introduce an optional new IE for NR-CA,
  [intraBandNonColocatedCA-r18] for
  UE supporting type 2 UE capability on NR-CA operation.
```

Moreover, UE type switching between the Type 1 and Type 2 has also been discussed. For example, in the RAN4 #106bis-e meeting, it is proposed that a UE supporting Type-2 shall support a function to switch between Type-1 and Type-2 based on a request from a BS.

In the RAN4 #107 meeting, it is further discussed in R4-2310300 as follows. In the discussion so far, there is a consensus that the UE type can be switched between Type 1 and Type 2 based on network indication.

```
< Issue 2-2-2: How UE supporting Type 2 NR-CA/EN-DC behaves between Type 1
and Type 2 >
Proposals
Option 1-1:
  (Common for all options) Default UE configuration is Type 1 UE if new UE
  capability is not signalled or supported.
  Default UE configuration shall be Type 1 UE if capable to support new UE
  capability for NR-CA.
  Configure UE between Type 1 and Type 2 with the existing RRC Reconf.
    BS can switch between Type 1 and Type 2 using by setting
    ServingCellConfig.maxMIMO-Layers= 4, and 2, respectively during
    existing RRC Reconf.
    If there are critical and technical issues on reusing existing RRC Reconf.,
    RAN4 will discuss them in the future release or the maintenance part (i.e.
    Rel-18 for NR-CA and Rel-16 for EN-DC).
Option 2-2:
  (Common for all options) Default UE configuration is Type 1 UE if new UE
  capability is not signalled or supported.
  Default UE configuration shall be Type 2 UE if capable to support new UE
  capability for NR-CA.
  Configure UE between Type 1 and Type 2 with a new BS signalling.
WF: Agree with the majority view to complete Rel-18 UE RF part in this meeting,
according to TU budget.
```

In addition, in the RAN4 #106bis-e meeting, it is proposed that the UE supporting Type 2 can operate either Type 1 or Type 2 based on network signaling. It is understood the UE indicating the capability will work under a default UE type, and it can switch to the other UE type based on network indication.

FIG. 1B illustrates an example UE architecture with Type 2 associated with some example embodiments of the present disclosure, and FIG. 1C illustrates an example UE type switching between Type 1 and Type 2 associated with some example embodiments of the present disclosure. When the UE switches between different types, the UE may need to switch on/off some of the RF units, e.g., Rx chains. For instance, when the UE switches from Type 1 to Type 2, the UE may need to switch on the additional Rx chains and direct the data transmission from a single Rx chain to multiple Rx chains. Otherwise, when the UE switches from Type 2 to Type 1, as shown in FIG. 1C, some of the Rx chains may be bypassed and all the data would go through the single Rx chain.

It is observed that it may take some time, e.g., a switching period to have the new type of architecture take effect, and during the switching period, the data transmission on at least some of the Rx chains may be impacted. As of now, there is no effective way to support the UE type switching. To minimize the negative impact on data transmission, it is expected that the network is aware of the UE type switching and its potential impact and hence able to adjust the scheduling for the UE accordingly. Optimizing the UE type switching is still an important issue to be solved. This invention considers some enhancements on interactions between the UE and the BS for the UE type switching. For example, related radio resource management (RRM) requirements need to be discussed for the UE type switching.

According to embodiments of the present disclosure, there is provided a scheme for UE type switching. With this scheme, a terminal device transmits, to a network device, capability information indicating support of a plurality of types of the terminal device. Then, the network device transmits an indication for switching a type of the terminal device to the terminal device. Moreover, the terminal device performs type switching based on the indication and a requirement for an interruption caused by the type switching.

This scheme optimizes the type switching procedure by introducing the requirement for an interruption caused by type switching. With the requirement, the terminal device and network device are aligned on the interruption caused by the type switching. This may help the network device to adjust the cell configuration and/or data scheduling based on the requirement. In this way, it is allowed to minimize or avoid transmission failure due to the interruption caused by type switching, and thus improve resource utilization and transmission flexibility.

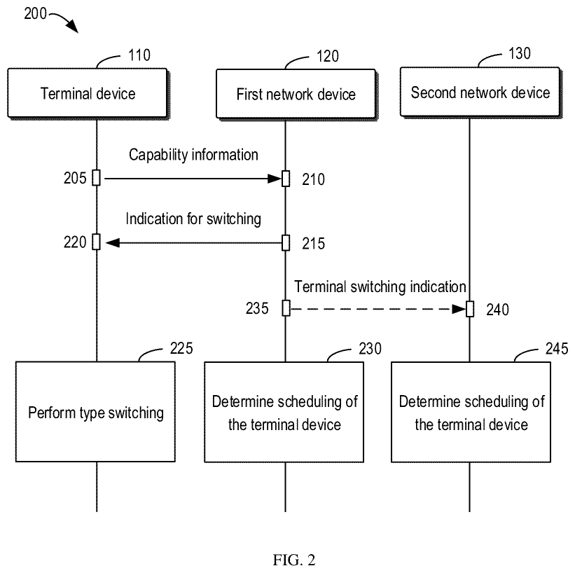

FIG. 2 illustrates a signaling flow 200 among a terminal device, a first network device, and a second network device according to some example embodiments of the present disclosure. For the purpose of discussion, the signaling flow 200 will be described with reference to FIG. 1A.

As shown in FIG. 2, the terminal device 110 transmits (205), to the first network device 120, capability information indicating support of a plurality of types of the terminal device. Accordingly, the first network device 120 receives (210) the capability information from the terminal device 110. For example, the type of the terminal device 110 comprises a UE architecture type. The capability information may be comprised in a radio access control (RRC) message.

As an example, the capability information may comprise one or more switching periods required for performing type switching at the terminal device 220. The terminal device 110 may indicate the switching period it needs for switching the UE type for the network side to determine how long the interruption caused by the type switching may last. As another example, the capability information may comprise one or more switching directions. The one or more switching directions may correspond to one or more switching periods. Alternatively or additionally, the capability information may further indicate whether an interruption caused by type switching is allowed for the one or more switching directions respectively. The terminal device 110 may indicate if the interruption is allowed at UE type switching for each of the one or more switching directions.

In some example embodiments where the terminal device 110 supports at least a first type and a second type, the switching directions may comprise a first switching direction from type 1 to type 2, and a second switching direction from type 2 to type 1. In this case, two different switching periods may be indicated respectively, i.e., a first switching period required for switching from the first type to the second type, and a second switching period required for switching from the second type to the first type. The first switching period or the second switching period may be set to zero. In the case where the first type is Type 1 and the second type is Type 2, the switching period from Type 2 to Type 1 may be set to zero i.e. no additional time is needed for UE type switching.

As a further example, the capability information may comprise one or more cells or carriers on which an interruption caused by type switching at the terminal device 110 is allowed (or expected). Such cell(s) or carrier(s) may also be referred to as victim cell(s) or carrier(s). For example, when the terminal device 110 switches from Type 1 to Type 2, the interruption may be allowed (or expected) on all intra-band serving cells. As another example, when the terminal device 110 switches from Type 2 to Type 1, the interruption may be allowed (or expected) or no interruption may be allowed (or expected) on specific carriers. As a further example, the terminal device 110 may indicate the victim carrier(s) (if any) where the interruption is allowed (or expected) at each switching. The one or more carriers may be indicated via indexes of the cells or carriers, or a bitmap may be used to indicate which one or more of the serving cells are victim carriers. As a further example, absence of the one or more cells may indicate there is no interruption at the type switching.

Alternatively or additionally, the capability information may comprise support of the type switching for non-collocated intra-band evolved-universal terrestrial radio access network new radio dual connectivity (EN-DC) and/or non-collocated intra-band new radio carrier aggregation (NR-CA). In this case, the one or more switching periods comprise at least one switching period for the EN-DC, and/or at least one switching period for the NR-CA. For example, different switching periods may be indicated for the EN-DC and the NR-CA respectively. The terminal device 110 may indicate a longer switching period when switching from Type 1 to Type 2 in case of the EN-DC compared to the NR-CA, as for EN-DC cases, different RAT may be considered.

Then, as shown in FIG. 2, based on the obtained capability information, the first network device 120 transmits (215), to the terminal device 110, an indication for switching a type of the terminal device 110. At the receiving side of the communication, the terminal device 110 receives (220) the indication from the first network device 120. In the embodiments where the terminal device 110 supports Type 1 and Type 2, the indication may indicate the type switching from Type 1 to Type 2, or the type switching from Type 2 to Type 1. The indication may be comprised in an RRC message or a medium access control (MAC) or layer 1 (L1) message.

The terminal device 110 may determine a requirement for an interruption caused by type switching based on the capability information and the indication. In other words, the terminal device 110 may be allowed the interruption according to the requirement when performing type switching, e.g., when switching the architecture type.

In some example embodiments, the requirement may comprise an interruption length, with up to which the terminal device 110 is allowed the interruption. The interruption length may be determined at least based on the switching period, the direction of the switching, and/or a subcarrier spacing (SCS) of the victim cell(s). As an example, the terminal device 110 may determine the interruption length at least based on a switching period corresponding to a switching direction of the switching indicated in the indication from the first network device 120, and/or a subcarrier spacing (SCS) of at least one cell or carrier (i.e. victim cell or carrier), corresponding to the switching direction, that may be affected by the interruption. For example, the interruption length may include at least the switching period for the corresponding direction of the switching. Different interruption lengths may be determined for different switching directions, for example, for Type 1->Type 2 switching and Type 2->Type 1 switching respectively.

In some example embodiments, the requirement may further comprise a processing time period required by the terminal device 110 for processing the indication from the first network device 120. The terminal device 110 may start to perform the type switching after the processing time period. The interruption caused by the type switching starts when the terminal device 110 starts to perform the type switching after the processing time period. In other words, the processing time period may be used to determine an interruption location from which the interruption starts. For example, after receiving the network signaling indicating the type switching, the interruption on victim cells or carriers may start after the processing time period within which the terminal device 110 has processed the network signaling.

In other words, the terminal device 110 is allowed an interruption of communication, e.g., on the victim cell(s) or carrier(s) according to an interruption window. The interruption window may be defined based on the interruption length and the location of the interruption as described above. For example, when the terminal device 110 receives the switching indication from the first network device 120, the interruption may start in several slots/symbols/micro-seconds after the switching indication, as the terminal device 110 may need to process the indication from the first network device 120 for the several slots/symbols/micro-seconds, and then perform the type switching according to the switching periods, and thus, the interruption may last during the switching length.

Then, as shown in FIG. 2, the terminal device 110 performs (225) the type switching based on the indication and the requirement. The terminal device 110 may perform the indicated type switching based on its capability. After the type switching, data transmission with the network side may be resumed. While switching the type of the terminal device 110, the terminal device 110 is allowed an interruption of communication, e.g., on the victim cell(s) or carrier(s) within the interruption length, in other words, the interruption window. As an example, If an intended victim cell is not indicated in the capability information or the interruption length and location fails to be determined, the interruption may not be performed/allowed.

Likewise, the first network device 120 may determine, based on the capability information and the indication, the requirement for the interruption caused by type switching at the terminal device 110. For example, the first network device 120 may determine the interruption length and the interruption location.

Then, the first network device 120 determines (230) scheduling of the terminal device 110 based on the requirement. In some example embodiments, the first network device 120 may prevent from scheduling the terminal device 110 based on the requirement. For example, the first network device 120 may prevent from scheduling the terminal device 110 after the processing time period and within the interruption length.

In some example embodiments, the first network device 120 may transmit (235), to a second network device 130, a terminal switching indication indicating switching of a type of the terminal device 110. Accordingly, the second network device 130 may receive (240) the terminal switching indication from the first network device 120. The terminal switching indication may comprise a switching period required by the terminal device 110 for performing the indicated switching. Alternatively or additionally, the terminal switching indication may comprise at least one cell or carrier i.e. victim cell(s) on which the interruption is allowed.

Likewise, the second network device 130 may determine, based on the terminal switching indication, the requirement for the interruption caused by type switching at the terminal device 110. Then, the second network device 130 determines (245) scheduling of the terminal device 110 based on the requirement. In some example embodiments, the second network device 130 may prevent from scheduling the terminal device 110 based on the requirement. For example, the second network device 130 may prevent from scheduling the terminal device 110 after the processing time period and within the interruption length.

As an example, the specification, for example, technical specification (TS) 38.133, may be modified as follows:
When UE receives a network indication [UETypeSwitchingType 1->2], the UE is allowed interruptions on the [VictimCells1->2] as indicated in the UE capability if UE is capable of [intraBandNonColocatedCA-r18], during the switching from Type 1 to Type 2,
With up to X1 slot as specified in Table 8.2.2.x.y-1.
When UE receives a network indication [UETypeSwitchingType 2->1], the UE is allowed interruptions on the [VictimCells2->1] as indicated in the UE capability if UE is capable of [intraBandNonColocatedCA-r18], during the switching from Type 1 to Type 2,
With up to X2 slot as specified in Table 8.2.2.x.y-1.

In this way, the terminal device can inform how fast it is supposed to perform the UE type switching and how much negative impact each switching may bring to other cells or carriers. With the specified interruption, the terminal device and network devices are aligned on how long the switching may last, in which symbol/slots, and on which carriers the data transmission will be interrupted. This may help the network devices to adjust the cell configuration and data scheduling based on the interruption requirements. Therefore, it is allowed to minimize or avoid transmission failure due to the interruption caused by type switching, and thus improve resource utilization and transmission flexibility.

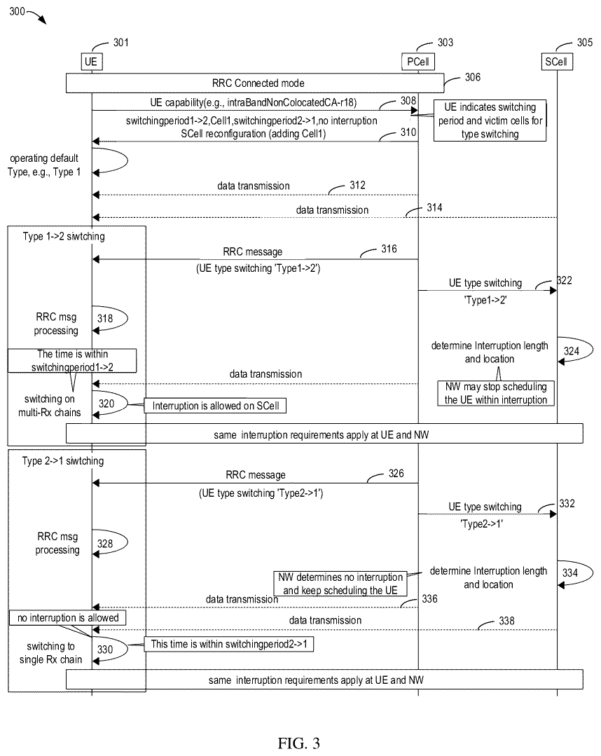

FIG. 3 illustrates an example UE type switching process according to some example embodiments of the present disclosure. It would be appreciated that the process flow 300 may be considered as a more specific example of the signaling flow 200 as shown in FIG. 2. Accordingly, the UE 301 may be an example of the terminal device 110. And as an example, the PCell 303 may be provided by the first network device 120, and the secondary cell (SCell) 305 may be provided by the second network device 130.

This example process is assuming an intra-band non-collocated NR CA scenario, but the similar procedure may be applied also to an EN-DC scenario, i.e., inter-band EN-DC scenario with overlapping DL bands.

As shown in FIG. 3, at 306, the UE 301 is connected with the PCell 303. At 308, the UE 301 transmits the UE capability information indicating it supports intra-band non-collocated CA. The UE capability information may indicate the UE 301 support a plurality of UE types, e.g., Type 1 and Type 2. Alternatively, the UE capability information may indicate the UE 301 supports UE Type 2, which implicitly means the UE 301 supports both Type 1 and Type 2 as Type 1 is a default UE type always being supported by the UE 301. In addition, the UE 301 may indicate, in the UE capability information, the switching periods it requires to switch UE type from Type 1 to Type 2 and from Type 2 to Type 1 respectively. In this case, as indicated, there is no interruption for Type 2 to Type 1 switching. The presence of the switching period may indicate the UE 301 supports the UE type switching, otherwise if the UE 301 indicates the capability of intra-band non-collocated CA but there is no switching period indicated in the UE capability information, the UE 301 may always operate under Type 2. The UE 301 may also indicate the victim cells/carriers where the interruption may happen at UE type switching.

At 310, the network configures the UE 301 with non-collocated CA by adding the SCell 305. The UE 301 operates under the default UE type, e.g., Type 1 after receiving the configuration. Then, at 312 and 314, the UE 301 receives data via a single Rx chain from the PCell 303 and SCell 305.

At 316, the network determines that the PCell 303 and the SCell 305 are non-collocated and transmits a network signal (e.g., an RRC message) asking the UE 301 to switch to Type 2. Alternatively or additionally, this step may be combined into step 310. That is, the network may indicate the UE type switching when adding the SCell 305.

Upon receiving the RRC message, the UE 301 takes some time to switch to Type 2. The UE 301 experiences a processing time period for processing the RRC message (at 318), and a switching period for switching from Type 1 to Type 2 (at 320). At 322, the PCell 303 indicates to the SCell 305 the UE type switching ‘Type 1->2’, for example, together with the switchingperiod1->2. At 324, the network determines the interruption length of interruption based on the received switchingperiod1->2 and may not schedule the UE 301 during this interruption length on the indicated victim cell(s), i.e., SCell 305. The UE 301 may experience an interruption during the interruption length on the SCell 305. After the UE switches to Type 2, the network may recover the data transmission on victim cell(s).

Similarly, at 326, the network indicates the UE type switching from Type 2 to Type 1 via an RRC message, e.g., when the PCell 303 and the SCell 305 are co-located-deployed. The UE 301 may process the RRC message (at 328) and then perform the type switching (at 330) within the target time window as described above. At 332, the PCell 303 indicates to the SCell 305 the UE type switching ‘Type 2->1’, for example, together with the switchingperiod2->1. At 334, the network determines that no interruption may be expected as indicated in the UE capability information. Hence the interruption may not be allowed on the PCell 303 or the SCell 305 due to UE type switching. At 336 and 338, data transmissions between the UE 301 and the network are performed without any interruption.

Operations and features as described above with reference to FIG. 2 are likewise applicable to the process 300 and have similar effects. For the purpose of simplification, the details will be omitted.

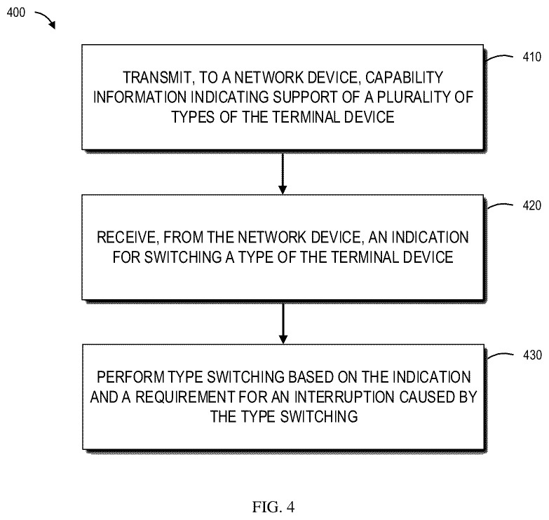

FIG. 4 illustrates a flowchart 400 of a method implemented at a terminal device according to some embodiments of the present disclosure. For the purpose of discussion, the method 400 will be described from the perspective of the terminal device 110 with reference to FIG. 1A.

At block 410, the terminal device 110 transmits, to a first network device 120, capability information indicating support of a plurality of types of the terminal device 110. At block 420, the terminal device 110 receives, from the first network device 120, an indication for switching a type of the terminal device 110. At block 430, the terminal device 110 performs type switching based on the indication and a requirement for an interruption caused by the type switching.

In some example embodiments, the terminal device 110 may further determine the requirement based on the capability information and the indication.

In some example embodiments, the type of the terminal device 110 may comprise a user equipment (UE) architecture type.

In some example embodiments, the capability information may further comprise at least one of the following: one or more switching periods required for performing type switching; one or more switching directions; one or more cells or carriers on which the interruption is allowed; or support of the type switching for evolved-universal terrestrial radio access network new radio dual connectivity (EN-DC) and/or non-collocated intra-band new radio carrier aggregation (NR CA).

In some example embodiments, the requirement may comprise an interruption length, and the terminal device 110 may further determine the interruption length at least based on at least one of the following: a switching period, corresponding to a switching direction of the switching indicated in the indication, of the one or more switching periods; and a subcarrier spacing (SCS) of at least one cell or carrier, corresponding to the switching direction, of the one or more cells or carriers. In some example embodiments, the terminal device 110 is allowed an interruption with up to the interruption length.

In some example embodiments, the plurality of types may comprise a first type and a second type, and the one or more switching periods comprise: a first switching period required for switching from the first type to the second type; and a second switching period required for switching from the second type to the first type. In some example embodiments, the first switching period or the second switching period may be set to zero.

In some example embodiments, the one or more switching periods may comprise: at least one switching period for the EN-DC; and at least one switching period for the NR CA.

In some example embodiments, the capability information may further indicate whether an interruption caused by type switching is allowed for the one or more switching directions respectively.

In some example embodiments, the requirement may comprise a processing time period required by the terminal device 110 for processing the indication from the first network device 120, and the terminal device 110 starts to perform the type switching after the processing time period. In some example embodiments, the interruption starts when the terminal device 110 starts to perform the type switching after the processing time period.

In some example embodiments, the capability information may be comprised in a radio access control (RRC) message. Alternatively or additionally, the indication may be comprised in an RRC message.

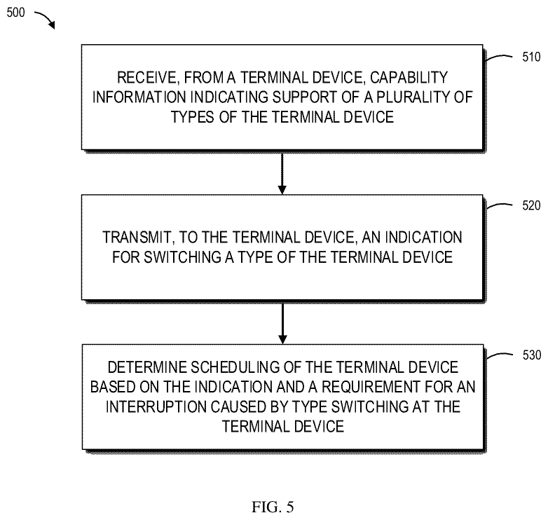

FIG. 5 illustrates a flowchart 500 of a method implemented at a first network device according to some embodiments of the present disclosure. For the purpose of discussion, the method 500 will be described from the perspective of the first network device 120 with reference to FIG. 1A.

At block 510, the first network device 120 receives, from a terminal device 110, capability information indicating support of a plurality of types of the terminal device 110. At block 520, the first network device 120 transmits, to the terminal device 110, an indication for switching a type of the terminal device 110. At block 530, the first network device 120 determines scheduling of the terminal device 110 based on the indication and a requirement for an interruption caused by type switching at the terminal device 110.

In some example embodiments, the first network device 120 may further determine the requirement based on the capability information and the indication.

In some example embodiments, the type of the terminal device 110 may comprise a user equipment (UE) architecture type.

In some example embodiments, the capability information may further comprise at least one of the following: one or more switching periods required for performing type switching; one or more switching directions; one or more cells or carriers on which the interruption is allowed; and support of the type switching for evolved-universal terrestrial radio access network new radio dual connectivity (EN-DC) and/or non-collocated intra-band new radio carrier aggregation (NR CA).

In some example embodiments, the requirement may comprises an interruption length, and wherein the first network device 120 is further caused to determine the interruption length at least based on at least one of the following: a switching period, corresponding to a switching direction of the switching indicated in the indication, of the one or more switching periods; and a subcarrier spacing (SCS) of at least one cell or carrier, corresponding to the switching direction, of the one or more cells or carriers. In some example embodiments, the terminal device 110 is allowed an interruption with up to the interruption length.

In some example embodiments, to determine the scheduling, the first network device 120 may prevent from scheduling the terminal device 110 based on the requirement.

In some example embodiments, the plurality of types may comprise a first type and a second type, and the one or more switching periods may comprise: a first switching period required for switching from the first type to the second type; and a second switching period required for switching from the second type to the first type. In some example embodiments, the first switching period or the second switching period may be set to zero.

In some example embodiments, the one or more switching periods may comprise: at least one switching period for the EN-DC; and at least one switching period for the NR CA.

In some example embodiments, the capability information may further indicate whether an interruption caused by type switching is allowed for the one or more switching directions respectively.

In some example embodiments, the requirement comprises a processing time period required by the terminal device 110 for processing the indication from the network device, and the terminal device 110 starts to perform the type switching after the processing time period. In some example embodiments, the interruption starts when the terminal device 110 starts to perform the type switching after the processing time period. In some example embodiments, to determine the scheduling of the terminal device 110, the first network device 120 may prevent from scheduling the terminal device 110 after the processing time period and within the interruption length.

In some example embodiments, the capability information may be comprised in a radio access control (RRC) message. Alternatively or additionally, the indication may be comprised in an RRC message.

In some example embodiments, the first network device 120 may further transmit, to a second network device 130, a terminal switching indication indicating switching of a type of the terminal device 110. In some example embodiments, the terminal switching indication may comprise at least one of the following: a switching period required by the terminal device 110 for performing the indicated switching; and at least one cell or carrier on which the interruption is allowed.

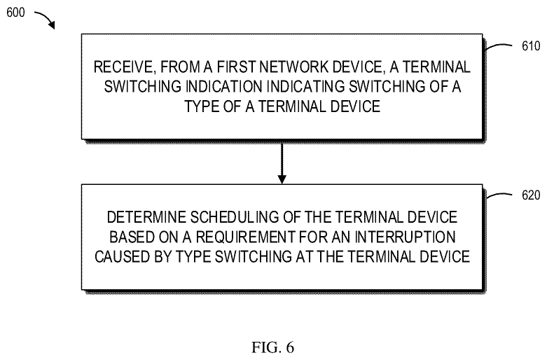

FIG. 6 illustrates a flowchart 600 of a method implemented at a second network device according to some embodiments of the present disclosure. For the purpose of discussion, the method 600 will be described from the perspective of the second network device 130 with reference to FIG. 1A.

At block 610, the second network device 130 receives, from a first network device 120, a terminal switching indication indicating switching of a type of a terminal device 110. At block 620, the second network device 130 determines scheduling of the terminal device 110 based on a requirement for an interruption caused by type switching at the terminal device 110.

In some example embodiments, the second network device 130 may further determine the requirement based on the terminal switching indication.

In some example embodiments, the type of the terminal device 110 may comprise a user equipment (UE) architecture type.

In some example embodiments, the terminal switching indication may comprise at least one of the following: a switching period required by the terminal device 110 for performing the indicated switching; and at least one cell or carrier on which the interruption is allowed. In some example embodiments, the requirement may comprise an interruption length, and wherein the second network device 130 is further caused to determine the interruption length at least based on at least one of the following: the switching period; and a subcarrier spacing (SCS) of the at least one cell or carrier. In some example embodiments, the terminal device 110 may be allowed an interruption with up to the interruption length.

In some example embodiments, to determine the scheduling, the second network device 130 may prevent from scheduling the terminal device 110 based on the requirement.

In some example embodiments, the requirement may comprise a processing time period required by the terminal device 110 for processing the indication from the network device, and the terminal device 110 starts to perform the type switching after the processing time period. In some example embodiments, the interruption may start when the terminal device 110 starts to perform the type switching after the processing time period. In some example embodiments, to determine the scheduling of the terminal device 110, the second network device 130 may prevent from scheduling the terminal device 110 after the processing time period and within the interruption length.

In some example embodiments, an apparatus capable of performing the method 400 (for example, the terminal device 110) may comprise means for performing the respective steps of the method 400. The means may be implemented in any suitable form. For example, the means may be implemented in a circuitry or software module.

In some example embodiments, the apparatus comprises means for transmitting, to a network device, capability information indicating support of a plurality of types of the terminal device; means for receiving, from the network device, an indication for switching a type of the terminal device; and means for performing type switching based on the indication and a requirement for an interruption caused by the type switching.

In some example embodiments, the apparatus further comprises means for determining the requirement based on the capability information and the indication.

In some example embodiments, the type of the terminal device comprises a user equipment (UE) architecture type.

In some example embodiments, the capability information further comprises at least one of the following: one or more switching periods required for performing type switching; one or more switching directions; one or more cells or carriers on which the interruption is allowed; or support of the type switching for evolved-universal terrestrial radio access network new radio dual connectivity (EN-DC) and/or non-collocated intra-band new radio carrier aggregation (NR CA).

In some example embodiments, the requirement comprises an interruption length, and wherein the terminal device is further caused to determine the interruption length at least based on at least one of the following: a switching period, corresponding to a switching direction of the switching indicated in the indication, of the one or more switching periods; and a subcarrier spacing (SCS) of at least one cell or carrier, corresponding to the switching direction, of the one or more cells or carriers. In some example embodiments, the terminal device is allowed an interruption with up to the interruption length.

In some example embodiments, the plurality of types comprise a first type and a second type, and the one or more switching periods comprise: a first switching period required for switching from the first type to the second type; and a second switching period required for switching from the second type to the first type. In some example embodiments, the first switching period or the second switching period is set to zero.

In some example embodiments, the one or more switching periods comprise: at least one switching period for the EN-DC; and at least one switching period for the NR CA.

In some example embodiments, the capability information further indicates whether an interruption caused by type switching is allowed for the one or more switching directions respectively.

In some example embodiments, the requirement comprises a processing time period required by the terminal device for processing the indication from the network device, and the terminal device starts to perform the type switching after the processing time period. In some example embodiments, the interruption starts when the terminal device starts to perform the type switching after the processing time period. In some example embodiments, the capability information is comprised in a radio access control (RRC) message, or the indication is comprised in an RRC message.

In some embodiments, the apparatus further comprises means for performing other steps in some embodiments of the method 400. In some embodiments, the means comprises at least one processor and at least one memory including computer program code, the at least one memory and computer program code configured to, with the at least one processor, cause the performance of the apparatus.

In some example embodiments, an apparatus capable of performing the method 500 (for example, the first network device 120) may comprise means for performing the respective steps of the method 500. The means may be implemented in any suitable form. For example, the means may be implemented in a circuitry or software module.

In some example embodiments, the apparatus comprises means for receiving, from a terminal device, capability information indicating support of a plurality of types of the terminal device; means for transmitting, to the terminal device, an indication for switching a type of the terminal device; and means for determining scheduling of the terminal device based on the indication and a requirement for an interruption caused by type switching at the terminal device.

In some example embodiments, the apparatus further comprises means for determining the requirement based on the capability information and the indication.

In some example embodiments, the type of the terminal device comprises a user equipment (UE) architecture type.

In some example embodiments, the capability information further comprises at least one of the following: one or more switching periods required for performing type switching; one or more switching directions; one or more cells or carriers on which the interruption is allowed; and support of the type switching for evolved-universal terrestrial radio access network new radio dual connectivity (EN-DC) and/or non-collocated intra-band new radio carrier aggregation (NR CA).

In some example embodiments, the requirement comprises an interruption length, and wherein the first network device is further caused to determine the interruption length at least based on at least one of the following: a switching period, corresponding to a switching direction of the switching indicated in the indication, of the one or more switching periods; and a subcarrier spacing (SCS) of at least one cell or carrier, corresponding to the switching direction, of the one or more cells or carriers. In some example embodiments, the terminal device is allowed an interruption with up to the interruption length. In some example embodiments, the means for determining the scheduling comprises means for preventing from scheduling the terminal device based on the requirement.

In some example embodiments, the plurality of types comprise a first type and a second type, and the one or more switching periods comprise: a first switching period required for switching from the first type to the second type; and a second switching period required for switching from the second type to the first type. In some example embodiments, the first switching period or the second switching period is set to zero.

In some example embodiments, the one or more switching periods comprise: at least one switching period for the EN-DC; and at least one switching period for the NR CA.

In some example embodiments, the capability information further indicates whether an interruption caused by type switching is allowed for the one or more switching directions respectively.

In some example embodiments, the requirement comprises a processing time period required by the terminal device for processing the indication from the network device, and the terminal device starts to perform the type switching after the processing time period. In some example embodiments, the interruption starts when the terminal device starts to perform the type switching after the processing time period. In some example embodiments, the means for determining the scheduling of the terminal device comprises means for preventing from scheduling the terminal device after the processing time period and within the interruption length.

In some example embodiments, the capability information is comprised in a radio access control (RRC) message, or the indication is comprised in an RRC message.

In some example embodiments, the apparatus further comprises means for transmitting, to a second network device, a terminal switching indication indicating switching of a type of the terminal device. In some example embodiments, the terminal switching indication comprises at least one of the following: a switching period required by the terminal device for performing the indicated switching; and at least one cell or carrier on which the interruption is allowed.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some example embodiments, an apparatus capable of performing the method 600 (for example, the second network device 130) may comprise means for performing the respective steps of the method 600. The means may be implemented in any suitable form. For example, the means may be implemented in a circuitry or software module.

In some example embodiments, the apparatus comprises means for receiving, from a first network device, a terminal switching indication indicating switching of a type of a terminal device; and means for determining scheduling of the terminal device based on a requirement for an interruption caused by type switching at the terminal device.

In some example embodiments, the apparatus further comprises means for determining the requirement based on the terminal switching indication.

In some example embodiments, the type of the terminal device comprises a user equipment (UE) architecture type.

In some example embodiments, the terminal switching indication comprises at least one of the following: a switching period required by the terminal device for performing the indicated switching; and at least one cell or carrier on which the interruption is allowed. In some example embodiments, the requirement comprises an interruption length, and wherein the second network device is further caused to determine the interruption length at least based on at least one of the following: the switching period; and a subcarrier spacing (SCS) of the at least one cell or carrier. In some example embodiments, the terminal device is allowed an interruption with up to the interruption length.

In some example embodiments, the means for determining the scheduling comprises means for preventing from scheduling the terminal device based on the requirement.

In some example embodiments, the requirement comprises a processing time period required by the terminal device for processing the indication from the network device, and the terminal device starts to perform the type switching after the processing time period. In some example embodiments, the interruption starts when the terminal device starts to perform the type switching after the processing time period. In some example embodiments, the means for determining the scheduling of the terminal device comprises means for preventing from scheduling the terminal device after the processing time period and within the interruption length.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

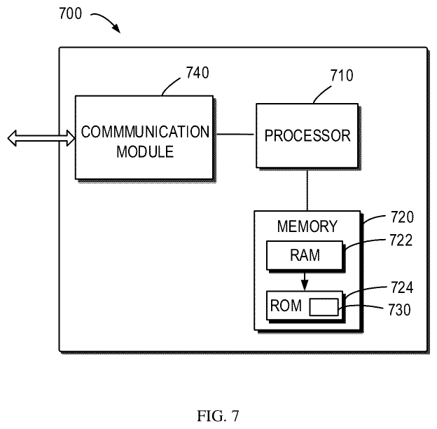

FIG. 7 illustrates a simplified block diagram of a device 700 that is suitable for implementing some example embodiments of the present disclosure. The device 700 may be provided to implement the communication device, for example, the terminal device 110, the first network device 120, or the second network device 130 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 and 3. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

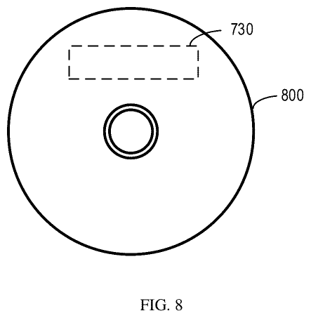

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carrying or holding the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 4 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device, comprising:
at least one processor; and
at least one memory storing instructions that, when executed by the at least one processor, cause the terminal device at least to:
transmit, to a network device, capability information indicating support of a plurality of types of the terminal device;
receive, from the network device, an indication for switching a type of the terminal device; and
perform type switching based on the indication and a requirement for an interruption caused by the type switching.

2. The terminal device of claim 1, wherein the terminal device is further caused to:
determine the requirement based on the capability information and the indication.

3. The terminal device of claim 1, wherein the type of the terminal device comprises a user equipment (UE) architecture type.

4. The terminal device of claim 1, wherein the capability information further comprises at least one of the following:
one or more switching periods required for performing type switching;
one or more switching directions;
one or more cells or carriers on which the interruption is allowed;
support of the type switching for evolved-universal terrestrial radio access network new radio dual connectivity (EN-DC) and/or non-collocated intra-band new radio carrier aggregation (NR-CA); or
whether an interruption caused by type switching is allowed for the one or more switching directions respectively.

5. The terminal device of claim 4, wherein the requirement comprises an interruption length, and wherein the terminal device is further caused to determine the interruption length at least based on at least one of the following:
a switching period, corresponding to a switching direction of the switching indicated in the indication, of the one or more switching periods, or
a subcarrier spacing (SCS) of at least one cell or carrier, corresponding to the switching direction, of the one or more cells or carriers; and
wherein the terminal device is allowed an interruption up to the interruption length.

6. The terminal device of claim 4, wherein the plurality of types comprise a first type and a second type, and the one or more switching periods comprise:
a first switching period required for switching from the first type to the second type; and
a second switching period required for switching from the second type to the first type.

7. The terminal device of claim 6, wherein the first switching period or the second switching period is set to zero.

8. The terminal device of claim 4, wherein the one or more switching periods comprise:
at least one switching period for the EN-DC; and
at least one switching period for the NR-CA.

9. The terminal device of claim 1, wherein the requirement comprises a processing time period required by the terminal device for processing the indication from the network device, and the terminal device starts to perform the type switching after the processing time period.

10. The terminal device of claim 9, wherein the interruption starts when the terminal device starts to perform the type switching after the processing time period.

11. The terminal device of claim 1, wherein at least one of:
the capability information is comprised in a radio access control (RRC) message; or
the indication is comprised in an RRC message.

12. A first network device, comprising:
at least one processor; and
at least one memory storing instructions that, when executed by the at least one processor, cause the first network device at least to:
receive, from a terminal device, capability information indicating support of a plurality of types of the terminal device;
transmit, to the terminal device, an indication for switching a type of the terminal device; and
determine scheduling of the terminal device based on the indication and a requirement for an interruption caused by type switching at the terminal device.

13. The first network device of claim 12, wherein the capability information further comprises at least one of the following:
one or more switching periods required for performing type switching;
one or more switching directions;
one or more cells or carriers on which the interruption is allowed;
support of the type switching for evolved-universal terrestrial radio access network new radio dual connectivity (EN-DC) and/or non-collocated intra-band new radio carrier aggregation (NR-CA); or
whether an interruption caused by type switching is allowed for the one or more switching directions respectively.

14. The first network device of claim 13, wherein the requirement comprises an interruption length, and wherein the first network device is further caused to determine the interruption length at least based on at least one of the following:
a switching period, corresponding to a switching direction of the switching indicated in the indication, of the one or more switching periods, or
a subcarrier spacing (SCS) of at least one cell or carrier, corresponding to the switching direction, of the one or more cells or carriers; and
wherein the terminal device is allowed an interruption up to the interruption length.

15. The first network device of claim 12, wherein the first network device is caused to determine the scheduling by at least one of:
preventing from scheduling the terminal device based on the requirement; or
preventing from scheduling the terminal device after the processing time period and within the interruption length.

16. The first network device of claim 12, wherein the first network device is further caused to:
transmit, to a second network device, a terminal switching indication indicating switching of a type of the terminal device; and wherein the terminal switching indication comprises at least one of the following:
a switching period required by the terminal device for performing the indicated switching; and
at least one cell or carrier on which the interruption is allowed.

17. A second network device, comprising:
at least one processor; and
at least one memory storing instructions that, when executed by the at least one processor, cause the second network device at least to:
receive, from a first network device, a terminal switching indication indicating switching of a type of a terminal device; and
determine scheduling of the terminal device based on a requirement for an interruption caused by type switching at the terminal device.

18. The second network device of claim 17, wherein the terminal switching indication comprises at least one of the following:
a switching period required by the terminal device for performing the indicated switching; and
at least one cell or carrier on which the interruption is allowed.

19. The second network device of claim 18, wherein the requirement comprises an interruption length, and wherein the second network device is further caused to determine the interruption length at least based on at least one of the following:
the switching period, or
a subcarrier spacing (SCS) of the at least one cell or carrier; and
wherein the terminal device is allowed an interruption up to the interruption length.

20. The second network device of claim 17, wherein the second network device is caused to determine the scheduling by at least one of:
preventing from scheduling the terminal device based on the requirement; or
preventing from scheduling the terminal device after the processing time period and within the interruption length.
